(19) United States
(12) Patent Application Publication
(10) Pub. No.: US 2021/0176123 A1
(43) Pub. Date: Jun. 10, 2021

(54) AUTOMATED CONFIGURATION OF DEVICES OF A REMOTE NETWORK

(71) Applicant: VIASAT, INC., Carlsbad, CA (US)

(72) Inventors: Ian J. PLAMONDON, College Station, TX (US); Greg BOLTON, Bryan, TX (US); Jared L. DUTTON, Houston, TX (US)

(73) Assignee: VIASAT, INC., CARLSBAD, CA (US)

(21) Appl. No.: 17/180,587

(22) Filed: Feb. 19, 2021

Related U.S. Application Data
(63) Continuation of application No. PCT/US2018/047293, filed on Aug. 21, 2018.

(51) Int. Cl. H04L 12/24

(52) U.S. Cl. CPC H04L 41/0806; H04L 41/0886; H04L 41/0843; H04L 41/0816

(57) ABSTRACT

Described herein are systems, devices, and methods that that provide automated provisioning of devices installed at a remote network site. A network service provider system includes databases that store configuration details for network packages and software modules that: a) determine which devices are installed at a remote network site, b) translate the configuration data in the databases into configuration commands understood by the installed devices, and c) configure those devices using those commands. The automated provisioning of remote network devices can be implemented with little input from an installer physically located at the remote site. For example, providing a device identifier of a network controller initiates provisioning of the controller and attached network devices (e.g., access points, routers, bridges, switches, etc.). The provisioning of the controller and attached devices can then proceed with little or no further input from the installer.

### CROSS-REFERENCE TO RELATED APPLICATIONS

This application is a continuation of International Application No. PCT/US2018/047293 filed Aug. 21, 2018 and entitled “AUTOMATED CONFIGURATION OF DEVICES OF A REMOTE NETWORK,” which is incorporated by reference herein in its entirety for all purposes.

### BACKGROUND

### Field

The present disclosure relates to configuring or provisioning remote access points (e.g., part of managed wi-fi services) for use in a communications network.

### Description of Related Art

Network service providers can install remote network sites that provide customers access to a communications network. A remote network site can include one or more access points that provide a wireless network to which users can connect to access a larger network environment, such as the Internet. These remote network sites can be installed at public or private locations and can be configured to allow free access or paid access to the network. Such remote network sites allow the extension of a networking environment to remote locations or locations where users would otherwise not have access to the network.

In operation, a remote access point at a remote location establishes a connection to the Internet, for example, over a communications network provided by a network service provider. The communications network can be provided by a satellite network, a terrestrial network, or a combination of both. The remote access point must be properly configured to allow communication over the communications network. Deployment and configuration of these remote access points can be time-consuming and challenging to manage.

### SUMMARY

In a first aspect, a provider system is presented wherein the system is configured for automated configuration of devices installed at a remote site. The system includes a communications bus configured to receive network communication from a remote network site over a communications network. The system also includes a storage device comprising a provider database that stores configuration information for a plurality of network devices including a network controller and a network access point. The system also includes one or more processors configured to execute computer executable instructions stored on the storage device. The system also includes a device monitoring module that utilizes the one or more processors to receive a unique identifier of a controller installed at a remote network site over the communications network. The system also includes a network package module that utilizes the one or more processors to associate the received unique identifier with an ordered network package. The system also includes a scheduling module that utilizes the one or more processors to automatically generate a configuration script for the controller based on configuration information extracted from the provider database. The system also includes a plurality of platform interface modules that utilize the one or more processors to receive the configuration script for the controller, to select an appropriate platform interface module that is configured to interface with a platform of the controller, and to transmit configuration commands that automatically configure the controller based on the ordered network package.

In some embodiments of the first aspect, the provider database includes an inventory table that includes individual records for network equipment in an inventory of the provider. In further embodiments of the first aspect, individual records of the inventory table include a unique device identifier and a device type identifier indicating the type of equipment. In further embodiments of the first aspect, the provider database includes a configuration table that includes individual records for unique device type identifiers included in the inventory table. In further embodiments of the first aspect, individual records of the configuration table include the unique device type identifier and configuration data for configuring a device associated with the unique device type identifier. In further embodiments of the first aspect, the scheduling module is configured to generate the configuration script for the controller based at least in part on records of the configuration table associated with the unique device type identifier of the controller.

In some embodiments of the first aspect, the device monitoring module further utilizes the one or more processors to detect one or more network access points connected to the controller. In further embodiments of the first aspect, the scheduling module further utilizes the one or more processors to schedule access point configuration scripts for the one or more detected network access points. In further embodiments of the first aspect, the plurality of platform interface modules further utilizes the one or more processors to receive the access point configuration scripts, to select an appropriate platform interface module that is configured to interface with a platform of a detected access point, and to transmit configuration commands that automatically configure the detected access point based on the ordered network package. In further embodiments of the first aspect, the appropriate platform interface module for the detected access point is different from the appropriate platform interface module for the controller. In some further embodiments of the first aspect, the device monitoring module further utilizes the one or more processors to change a status of the controller and the one or more detected access points in the provider database based on results of the transmitted configuration commands.

In some embodiments of the first aspect, the communications network comprises a satellite communications system.

In a second aspect, a method is presented for automatically provisioning devices installed at a remote site to provide a wireless network. The method includes receiving, over a communications network, a communication from an installed controller at a remote network site, the communication including a unique device identifier of the installed controller. The method also includes automatically generating configuration commands using a provider database based at least in part on the unique device identifier of the installed controller, the configuration commands generated using a platform-specific module associated with the installed controller. The method also includes detecting, over the communications network, a network access point connected to the installed controller. The method also includes automatically generating configuration commands using a provider database based at least in part on a unique device identifier of the network access point, the configuration commands generated using a platform-specific module associated with the network access point.

In some embodiments of the second aspect, the platform-specific module associated with the installed controller is different from the platform-specific module associated with the network access point. In some embodiments of the second aspect, the method further includes identifying an associated network package order based at least in part on the unique device identifier of the installed controller. In some embodiments of the second aspect, the unique device identifier of the installed controller is a media access control address.

In some embodiments of the second aspect, the method further includes transmitting a block of network addresses to the installed controller. In further embodiments of the second aspect, the installed controller is configured to assign a network address to the network access point from the transmitted block of network addresses.

In some embodiments of the second aspect, the method further includes detecting, over the communications network, a second network access point connected to the installed controller. In further embodiments of the second aspect, the method further includes automatically generating second network access point configuration commands using a provider database based at least in part on a unique device identifier of the second network access point, the second network access point configuration commands generated using a platform-specific module associated with the second network access point that is different from the platform-specific module associated with the first network access point.

For purposes of summarizing the disclosure, certain aspects, advantages and novel features have been described herein. It is to be understood that not necessarily all such advantages may be achieved in accordance with any particular embodiment. Thus, the disclosed embodiments may be carried out in a manner that achieves or optimizes one advantage or group of advantages as taught herein without necessarily achieving other advantages as may be taught or suggested herein.

### BRIEF DESCRIPTION OF THE DRAWINGS

Various embodiments are depicted in the accompanying drawings for illustrative purposes, and should in no way be interpreted as limiting the scope of this disclosure. In addition, various features of different disclosed embodiments can be combined to form additional embodiments, which are part of this disclosure.

FIGS. 1A, 1B, and 1C illustrate diagrams of example network environments that include a provider system that provides automated configuration of devices at a remote network site.

FIG. 2 illustrates a block diagram of an example provider system configured to automate the provisioning of a remote network.

FIG. 3 illustrates a flow chart of an example method of automatically provisioning devices of a remote network.

FIG. 4 illustrates a flow chart of another example method of automatically provisioning devices of a remote network.

FIG. 5 illustrates a diagram of an example network environment that provides access to an automated provisioning system for configuring and installing a remote network site.

FIG. 6 illustrates a diagram demonstrating the interaction of various components of an example automated provisioning system.

### DETAILED DESCRIPTION OF SOME EMBODIMENTS

The headings provided herein, if any, are for convenience only and do not necessarily affect the scope or meaning of the claimed invention.

### Overview

When away from a home or office network, users frequently need to still be able to connect to a larger network, such as the Internet, using mobile devices such as smartphones, laptops, tablets, and other smart devices. Network service providers may satisfy this need by providing access to the Internet using remote network sites that include one or more access points or hot spots. These hot spots allow users to connect to the remote network site, for free or using a paid option, which provides the user access to the Internet and other communications networks. Examples of such hot spots can be typically found in hotels, airports, café s, etc.

Installation of these remote network sites can prove to be challenging, costly, and time-consuming. Because of some of the challenges inherent in setting up a remote network site, it may be required that an information technology specialist be present to manage the installation. The specialist may be required to physically install a remote access point or controller, for example, and configure the device on site to get the network up and running. In addition, with the variety of available network devices, it may be challenging for installers to be sufficiently familiar with all of the relevant configuration options for each type of device. Although such provisioning may be acceptable for a small number of units and/or at convenient locations, such a process does not easily scale and may be overly costly depending on the location of the remote network site.

Accordingly, to address these and other related issues, described herein are systems, devices, and methods that provide automated provisioning of devices installed at a remote network site. A network service provider, or provider, can implement a provider system that includes databases that store configuration details for installations and software modules that determine which devices are installed at a remote network site, translate the configuration data in the databases into files and/or commands that can be understood by the installed devices, and configure those devices using those files and/or commands. The automated provisioning of remote network devices can be implemented with little input from an installer physically located at the remote site. For example, in some embodiments the installer installs a network controller and enters a device identifier (e.g., a media access control address or MAC address) of the network controller to initiate provisioning of the controller and attached network devices (e.g., access points, routers, bridges, switches, etc.). The provisioning or configuring of the controller and attached devices can then proceed with little or no further input from the installer.

The disclosed systems, devices, and methods provide a number of advantages that improve the installation of remote networks, examples of which are described herein. For example, the process for configuring remote network devices can be automated. The controller can configure itself based on configuration data received from the provider system. The provider system can be configured to automatically discover devices connected to the remote network site. The controller can configure devices connected to it based on configuration data received from the provider system. Another advantage is that the configuration process is driven by the provider system rather than by remote personnel or systems, giving the provider greater control and flexibility. Another advantage is that the provider is able to track configuration of devices at the remote site. Another advantage is that the provider is capable of allocating IP addresses prior to installation, with these addresses being assigned by the remote network controller during the automated configuration process. Another advantage is that the provider system stores configuration data for multiple types of network devices which allows for automated configuration of many different types of network devices.

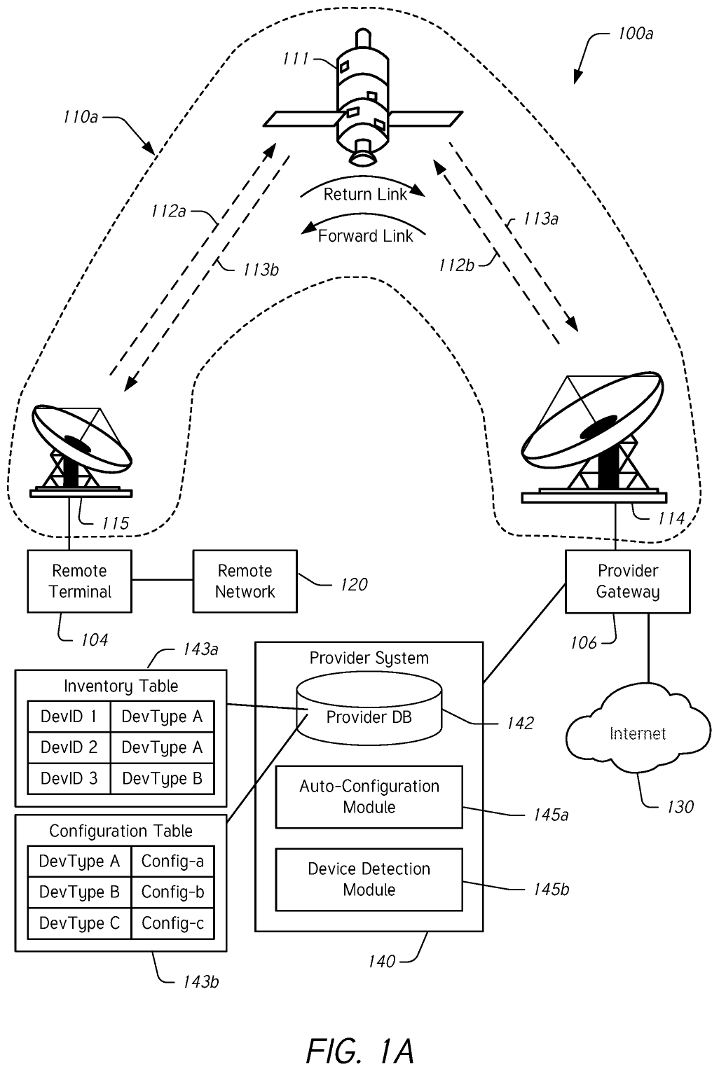

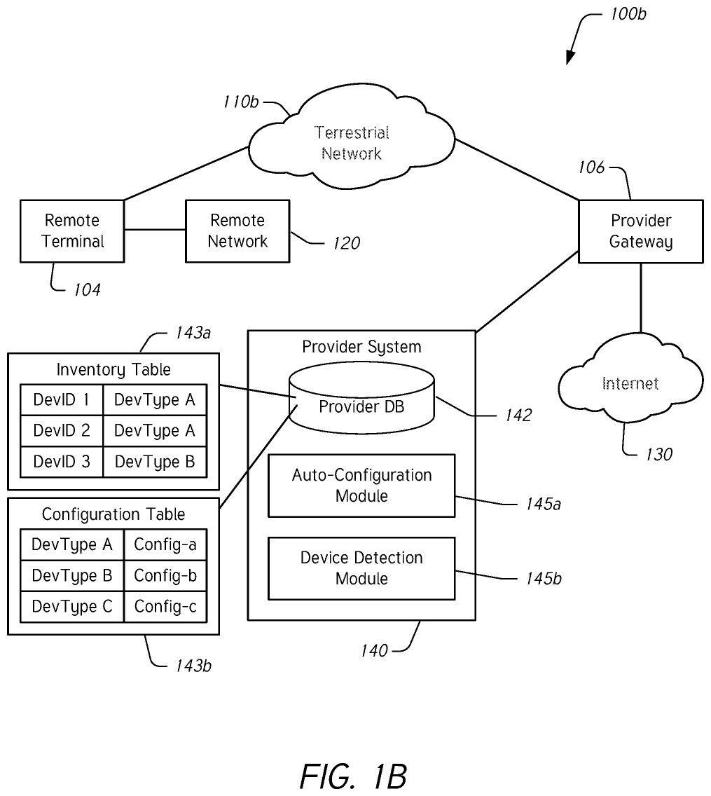

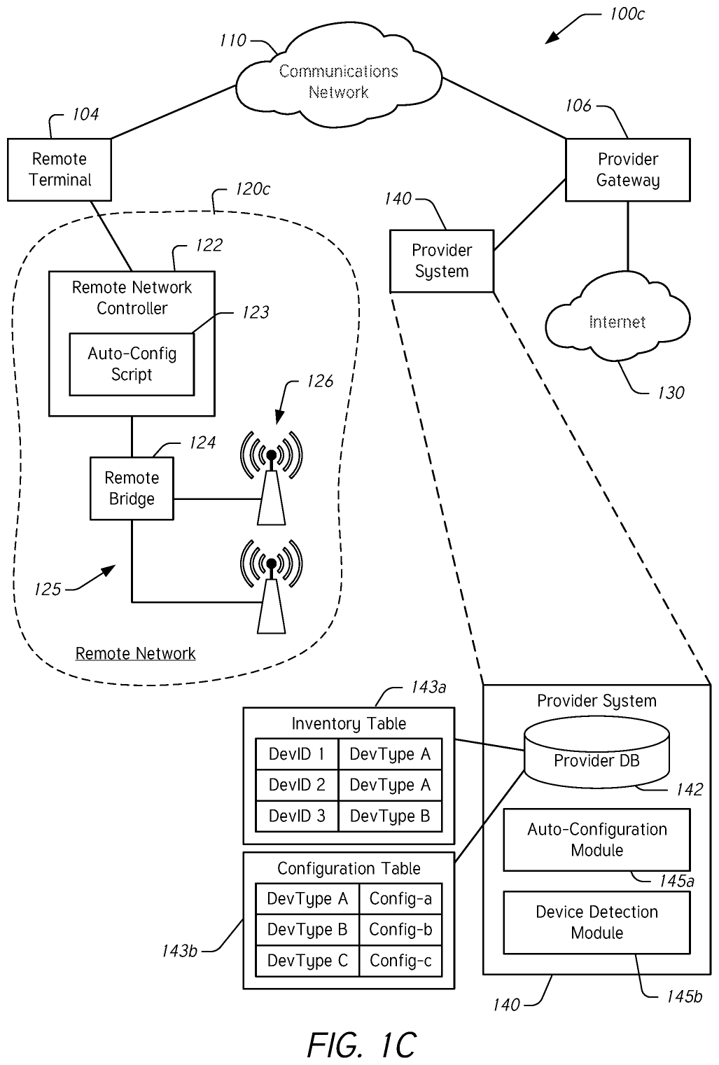

FIG. 1A illustrates a diagram of an example network environment 100a configured to provide automated provisioning of devices at a remote network site. The network environment 100a includes a satellite network 110a that communicatively couples a remote terminal 104 and a provider gateway 106 to one another and to a network (such as the Internet 130). The remote terminal 104 couples a remote network 120 to the satellite network 110a to provide access to the network (e.g., the Internet 130) for devices connected to the remote network 120. The network environment 100a also includes a provider system 140 coupled to the provider gateway 106 that automates the configuration or provisioning of one or more network devices (e.g., controllers, access points, routers, bridges, switches, etc.) installed as part of the remote network 120.

It should be noted that the term remote as used herein refers to a physical location that differs from that of the provider or provider system. Thus, a remote network includes a network that is implemented in a different building, different city, different state, or different country from the provider system. In portions of the description, the remote network and/or remote terminal may be referred to as a client network or a client terminal to indicate at a minimum that the terminal and/or network are installed on the premises of a client of the provider but may also indicate that one or more of the devices making up the remote network site are owned or operated by the client or another party rather than the provider.

The network environment 100a may utilize various network architectures that include space and ground segments. For example, the space segment may include one or more satellites, while the ground segment may include one or more satellite user terminals, gateway terminals, network operations centers (NOCs), satellite and gateway terminal command centers, and/or the like. Some of these elements are not shown in the figure for clarity. In some embodiments, the satellite network 110a can include a geosynchronous earth orbit (GEO) satellite or satellites, a medium earth orbit (MEO) satellite or satellites, and/or a low earth orbit (LEO) satellite or satellites.

The remote terminal 104 is configured to route data received from any device connected to the remote network 120 to the satellite network 110a (via a remote satellite transceiver 115). The remote terminal 104 can include a router or other similar device to route network data. The satellite network 110a includes a forward link for sending information from the provider gateway 106 to the remote terminal 104, and a return link for sending information from the remote terminal 104 to the provider gateway 106. The forward link includes a transmission path from the provider gateway 106 through a gateway satellite transceiver 114, through a satellite 111 via a satellite uplink channel 112b, to the remote satellite transceiver 115 via a satellite downlink channel 113b, and to the remote terminal 104. The return link includes a transmission path from the remote satellite transceiver 115, to the satellite 111 via the satellite uplink channel 112a, to the gateway satellite transceiver 114 via the satellite downlink channel 113a, and to the provider gateway 106. Each transmission channel may utilize multiple satellites and transceivers.

The remote terminal 104 is configured to transmit data to the provider gateway 106 through the satellite network 110a via the return link. After reaching the provider gateway 106, the data can then be directed to the Internet 130. Data from the Internet 130 can be sent to the remote terminal 104 by the provider gateway 106 via the forward link of the satellite network 110a.

The provider gateway 106 may be referred to as a hub or ground station. In certain embodiments, the provider gateway 106 is configured or designed to service forward uplink signals 112b to a satellite 111, and to return downlink signals 113a from the satellite 111. The provider gateway 106 may also schedule traffic to and/or from the remote terminal 104.

The provider gateway 106 may also provide an interface between the Internet 130 and the satellite 111 and/or another network. The provider gateway 106 may receive data and information from the Internet 130 that is directed to the remote terminal 104. The provider gateway 106 may format the data and information for delivery to the remote terminal 104 via the satellite 111. The provider gateway 106 may also receive signals carrying data and information from the satellite 111. This data and information may be transmitted by the remote terminal 104 and directed to destinations accessible via the Internet 130. The provider gateway 106 may format this data and information for delivery via the Internet 130. The Internet 130 may connect the provider gateway 106 with other gateway routing devices that may be in communication with the satellite 111 or with other satellites. In some embodiments, part or all of the provider gateway 106 can be located in a virtual device residing in a public or private computing cloud.

The satellite 111 may be a geosynchronous satellite that is configured to receive and transmit signals. The satellite 111 may receive the forward uplink signals 112b from the provider gateway 106 and transmit one or more corresponding forward downlink signals 113b to one or more remote terminals (e.g., remote terminal 104). The satellite 111 may also receive one or more return uplink signals 112a from one or more user terminals (e.g., remote terminal 104) and transmit corresponding return downlink signals 113a to the provider gateway 106.

The provider gateway 106 is also coupled to the provider system 140 through a communications network that provides the provider system 140 access to the remote network 120. This allows the provider system 140 to communicate with devices on the remote network 120, thereby enabling automated configuration of devices installed at the remote network 120 through the provider gateway 106. The provider system 140 can also be configured to discover devices connected to the remote network 120. The provider system 140 can also be configured to monitor the status of devices connected to the remote network 120 through the provider gateway 106. The provider system 140 can also be configured to send configuration data and/or configuration commands to devices connected to the remote network 120 through the provider gateway 106. In some embodiments, the remote network 120 includes at least a controller and one or more access point (“AP”) devices. The remote network 120 may also include one or more switches, bridges, and/or routers.

The provider system 140 includes a provider database 142, an auto-configuration module 145a, and a device detection module 145b that are configured to provide data and functionality that enables the automated provisioning of devices installed at the remote network 120.

The provider database 142 includes an inventory table 143a and a configuration table 143b, among other tables. The inventory table 143a includes a record for each piece of network equipment in the inventory of the provider. A record in the inventory table 143a can include, for example and without limitation, a unique device identifier (e.g., “DevID”) for each piece of equipment in the provider's inventory and an identifier indicating the type of the equipment (e.g., “DevType”). The DevType entry identifies the function of the device (e.g., controller, access point device, switch, bridge, router, etc.). The DevType entry can also be used to indicate a device model where multiple models of the device are available (e.g., the manufacturer and manufacturer's product number).

The configuration table 143b includes a record for unique DevTypes included in the inventory table 143a. Records in the configuration table 143b include the DevType and configuration data for configuring that type of device. Examples of configuration data include, for example and without limitation, firmware versions, port settings, transmit power levels, service set identifier (SSID), routing policies, security policies, and the like. The configuration table 143b allows for automated configuration of a variety of devices including different models (e.g., controllers made by different manufacturers) of the same type of network device.

The provider database 142 can include other database tables for the management of remote network sites. For example, the provider database 142 can include a network package table that includes entries for each device in a package to be installed at a particular remote network site. The network package table can include entries for each device and a status of that device (e.g., pending, configuring, configured, etc.). This allows the provider system 140 to track and to update the configuration process of the controller and individual network devices at a remote site until the configuration process is complete. The provider database 142 can include tables that associate allocated network address (e.g., IP addresses) to the devices in the network package table. In some embodiments, a block of available private network addresses equal in number to at least the number of devices in the package can be set aside for a new remote network installation prior to installation. This facilitates management of used and available network addresses for the provider. Other tables can include network packages being offered by the provider (e.g., remote network installation options for clients or potential customers). Such a table can include the number and types of devices and relevant configuration options.

The auto-configuration module 145a and the device detection module 145b can be implemented as software modules on the provider system 140. These software modules can include daemons or background processes as well as scheduled tasks managed by a scheduler program (e.g., cron jobs or crons). The software modules can be implemented in a computing device, across a number of computing devices, in a distributed computing environment, or wholly or in part in a virtual device residing in a public or private computing cloud.

The auto-configuration module 145a is configured to manage the status of devices being configured at the remote site in the provider database 142 and to configure the devices at the remote site. The auto-configuration module 145a extracts configuration data from, for example, the configuration table 143b and generates suitable files, commands, or the like to configure the devices at the remote site. The device detection module 145b is configured to identify devices connected to the remote network 120 after installation and automated configuration of a network controller.

Although not illustrated, it is to be understood that the provider system 140 includes one or more processors configured to execute computer executable instructions that implement the auto-configuration module 145a and the device detection module 145b. The provider system 140 also includes one or more data storage devices configured to store data associated with the provider database 142 as well as computer executable instructions. Examples of suitable processors and data storage devices are provided elsewhere herein.

FIG. 1B illustrates an example network environment 100b that includes a terrestrial network 110b that couples the remote terminal 104 to the provider gateway 106. The network environment 100b is similar to the network environment 100a described herein with reference to FIG. 1A with a terrestrial network 110b in place of the satellite network 110a. The remaining components of the network environment 100b provide the same relevant functionality as those components of the network environment 100a described herein with reference to FIG. 1A with the understanding that communication between the remote terminal 104 and the provider gateway 106 is provided using the terrestrial network 110b.

In various embodiments, the terrestrial network 110b may be any type of network and may include, for example, the Internet, an IP network, an intranet, a wide-area network (WAN), a local-area network (LAN), a virtual private network (VPN), a public switched telephone network (PSTN), a public land mobile network, a digital subscriber line (DSL), a cellular network, wireless local area network (WLAN) access point (AP) connected to DSL, or any combination of these.

FIG. 1C illustrates an example network environment 100c that includes a communications network 110 that couples the remote terminal 104 to the provider gateway 106. The communications network 110 includes a satellite network, a terrestrial network, or a combination of both a satellite network and a terrestrial network. The remaining components of the network environment 100c provide the same relevant functionality as those components of the network environment 100a described herein with reference to FIG. 1A with the understanding that communication between the remote terminal 104 and the provider gateway 106 is provided using the communications network 110.

The network environment 100c includes an example remote network 120c that includes a remote network controller 122 and other network devices 125 (e.g., a remote bridge 124 and two remote access points 126). The remote network controller 122 includes an auto-configuration script 123 configured to receive configuration data from the provider system 140 and to configure the remote network controller 122 based on the received configuration data.

An example of an installation and automated configuration process will now be provided with reference to the network environment 100c. First, an order for a network package is placed by a client or customer. An order is placed with the provider for a package of network devices for a new network (the remote network 120c) to be installed at a client's premises. The package includes a network controller 122 and network devices 125 that include a bridge 124, and two wireless access point (“AP”) devices 126. The provider system 140 creates an associated network package table in the provider database 142 that includes a record for each of the devices in the package and a status of the device. Table 1 is an example of the associated network package table created by the provider system 140.

TABLE 1

| Device | Status |
|---|---|
| DevID of Controller | Pending |
| DevID of Bridge | Pending |
| DevID of 1st wireless AP device | Pending |
| DevID of 2nd wireless AP device | Pending |

The provider system 140 also stores an allocation of a block of available private network addresses equal in number to at least the number of devices in the package. These addresses are set aside for the new network.

Second, the remote network controller 122 is installed and configured. The remote network controller 122 from the inventory of the provider is installed at the client premises and connected to the to the provider gateway 106 through the communications network 110. The unique ID (DevID) of the remote network controller 122 is sent over the communication network 110 to the provider system 140 through the provider gateway 106. The auto-configuration module 145a of the provider system 140 responds by (i) changing the status of the remote network controller 122 in the network package table from “pending” to “configuring,” (ii) configuring the remote network controller 122 in accordance with configuration data for the device type of the remote network controller 122 in the configuration table 143b, and (iii) providing the block of allocated private IP addresses to the remote network controller 122. Once the remote network controller 122 is configured, the auto-configuration module 145a changes the status of the remote network controller 122 in the network package table to “configured” from “configuring.” The auto-configuration script 123 on the remote network controller 122 is configured to manage configuration of the remote network controller 122 based on the configuration data received from the provider system 140.

Third and finally, the provider system 140 detects and configures the other devices connected to the remote network 120c. Once the remote network controller 122 is configured as described above, the device detection module 145b communicates with the remote network controller 122 to identify each of the other network devices installed at the client premises. In this example, the remote bridge 124 and two wireless AP devices 126 are identified. The remote network controller 122 assigns itself and each of the other network devices one of the private IP addresses from the allocated block of addresses. The auto-configuration module 145a then configures each of the network devices identified by the device detection module 145b by (i) changing the status of each device in the network package table to “configuring” from “pending,” and (ii) configuring the device in accordance with the configuration data for the device-type in the configuration table 143b. Once each device is configured, the auto-configuration module 145a changes the status of the device in the network package table to “configured” from “configuring.”

By way of summary, the process is an automated process by which a provider of network equipment configures a newly installed wireless network at a remotely located client. Once installed at the client premises, the remote network controller 122 contacts the provider system 140. The provider system 140 then sends configuration data by which the remote network controller 122 configures itself. Once the remote network controller 122 is configured, the provider system 140 discovers the other devices 125 (e.g., the remote bridge 124 and wireless APs 126) of the remote network 120c. The provider system 140 then sends configuration data by which the remote network controller 122 configures all of the other network devices 125. This automated configuration process is auto-driven by the modules on the provider system 140 and the auto-configuration script 123 on the remote network controller 122.

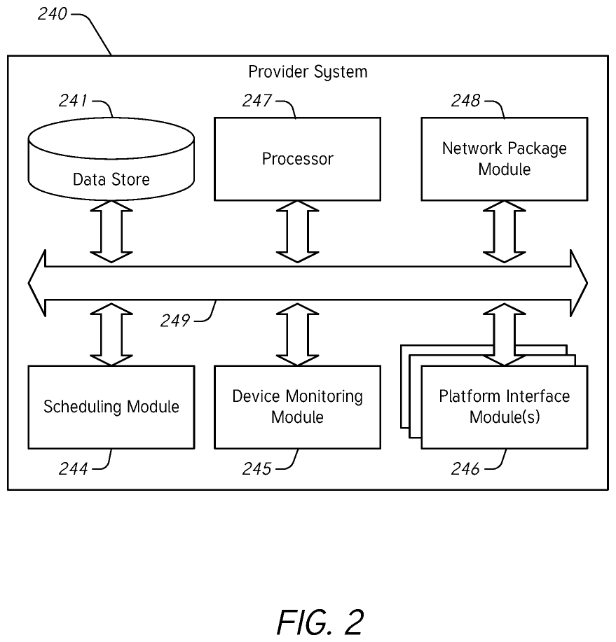

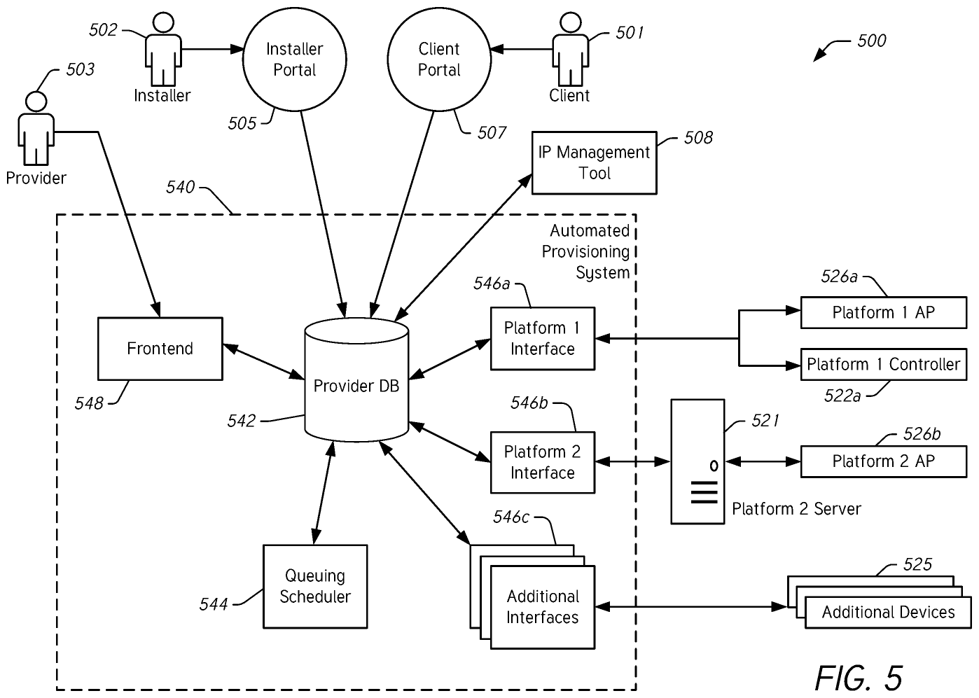

One particular advantage of the described automated configuration system and process is that the equipment can be configured without human intervention. Another advantage is that the controller configures itself based on data from the provider system. Another advantage is the described systems and methods can be implemented using network devices that do not include auto-configuration capabilities because the auto-configuration module is able to configure devices using stored configuration data and platform-specific crons or processes that interface with devices of different platforms, as described in greater detail herein with reference to FIGS. 2 and 5.

### Example Provider System

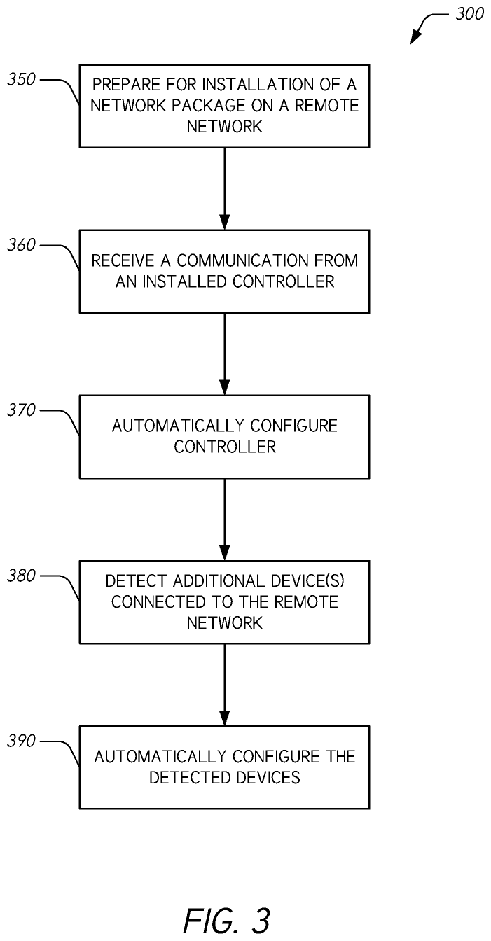

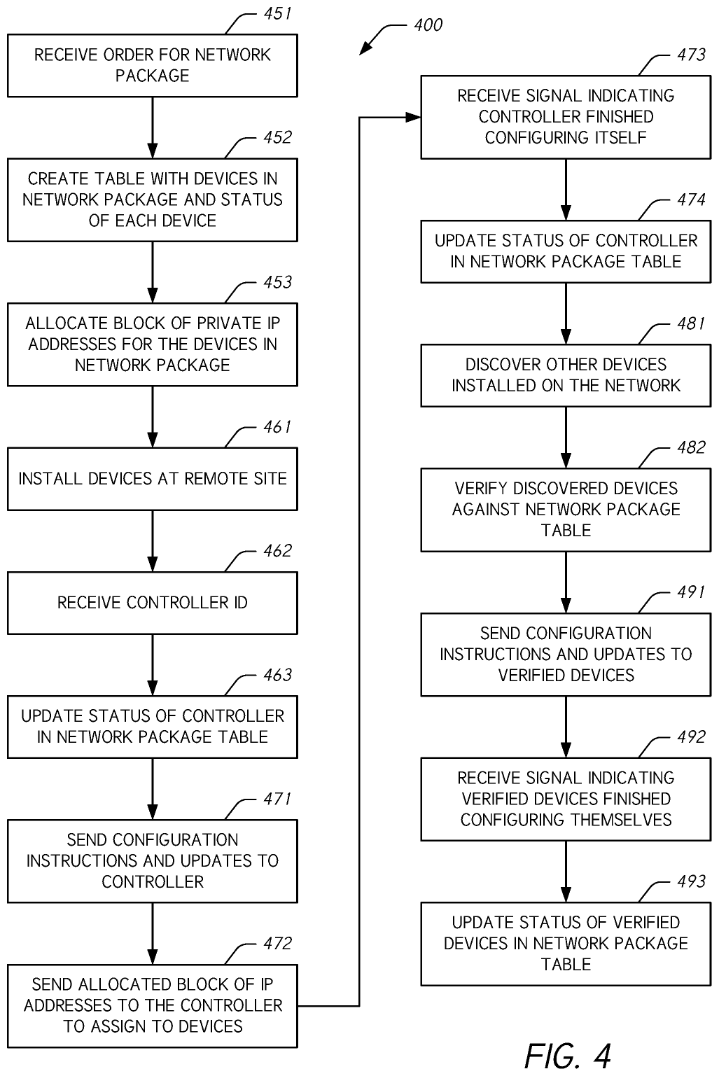

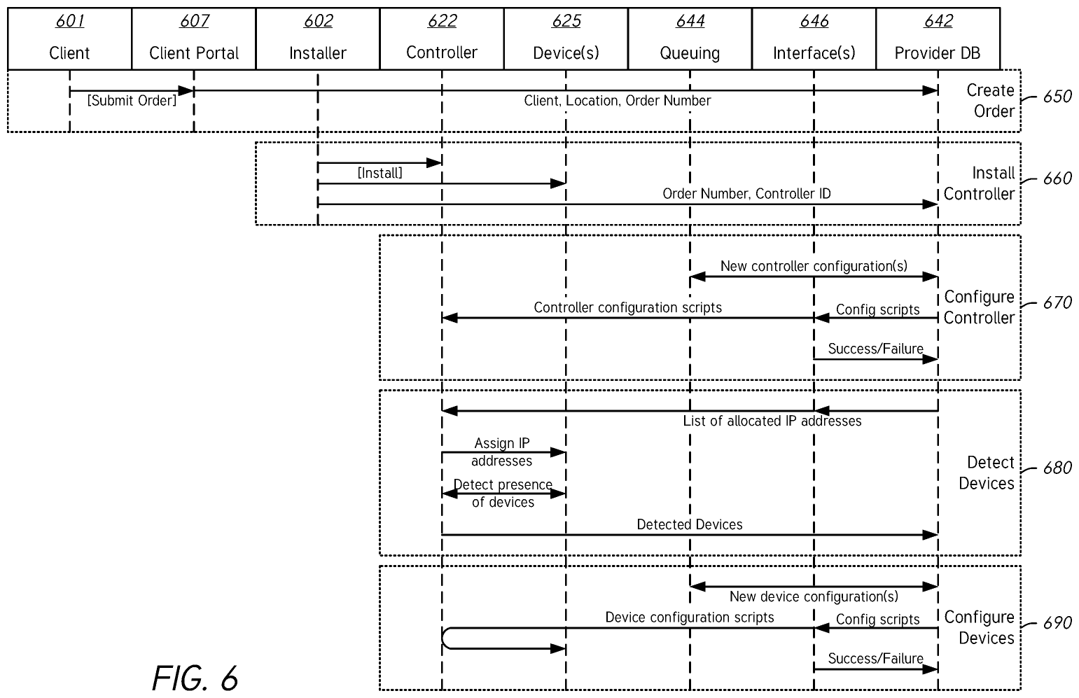

FIG. 2 illustrates an example of a provider system 240 that is configured to automatically configure a controller and one or more network devices at a remote site, such as on the premises of a client or customer. The remote site can be configured to provide a wireless network and thus may include a controller and one or more access points. The provider system 240 is configured to determine the devices present at the remote site and to configure each device based on configuration settings stored at the provider system 240. The provider system 240 is similar to the provider system 140 described herein with reference to FIGS. 1A-1C and can be implemented in the networking or communications environments there described. The provider system 240 can employ any method described herein for the automated provisioning of a wireless network at a remote site, such as the example methods 300 and 400 described herein with reference to FIGS. 3 and 4, respectively, and the process 600 described herein with reference to FIG. 6.

The provider system 240 can include hardware, software, and/or firmware components for the automated provisioning or configuring of a newly installed or modified wireless network having one or more hot spots to which users can connect to access the Internet. The provider system 240 is configured to provide automated provisioning of remote network devices. The provider system 240 is also configured to manage configuration settings of multiple devices and device types for the purpose of automated provisioning of such devices even where such capability is not natively provided by the devices. The provider system 240 can include a data store 241, one or more processors 247, a network package module 248, a scheduling module 244, a device monitoring module 245, and one or more platform interface modules 246. Components of the provider system 240 can communicate with one another, with external systems, and with other components of a network using communication bus 249. The provider system 240 can be implemented using one or more computing devices. For example, the provider system 240 can be implemented using a single computing device, multiple computing devices, a distributed computing environment, or it can be located in a virtual device residing in a public or private computing cloud. In a distributed computing environment, one or more computing devices can be configured to provide the modules described herein to provide the described functionality.

The provider system 240 includes the network package module 248. The network package module 248 is configured to handle orders for remote network installations, provide pre-defined remote network installation packages, identify matching installations to ordered packages, set aside network IP addresses for devices in an ordered network package, and the like. In some embodiments, a particular order is associated with a device identifier (e.g., a MAC address) of a controller. Once this information is entered by an installer, for example, the MAC address is used by the network package module 248 and the scheduling module 244 to link the controller to a particular order. Thus, entry of the device identifier of the controller by an installer can initiate the configuration process, associating the installation of the controller with an expected list of devices and targeted configurations of those devices.

The provider system 240 includes the scheduling module 244. The scheduling module 244 is configured to handle scheduling of configuration of network controllers and other attached network devices. The scheduling module 244 retrieves configuration information from an appropriate database and generates an appropriate configuration script to be executed at a scheduled time to configure devices. The scheduling module 244 can interact with the network package module 248 to determine which devices are a part of an installation based on an ordered package.

The provider system 240 includes the device monitoring module 245. The device monitoring module 245 is configured to handle the discovery of network controllers and other connected devices at a remote network site. The device monitoring module 245 is also configured to update device statuses in a database (e.g., configuring, configured, failed, etc.). The device monitoring module 245 is also configured to monitor the network connections of remote devices and can interface with network monitoring tools to determine this status.

The provider system 240 includes the platform interface modules 246. The platform interface modules 246 are configured to generate device- or platform-specific configuration commands based on the configuration scripts generated by the scheduling module 244. The configuration commands can be executed by a controller and/or other network devices to achieve a targeted configuration at a remote network site. The platform interface modules 246 can be configured to convert configuration options into device-specific and/or platform-specific commands. The provider system 240 can include a platform interface module for each platform to be configured.

The provider system 240 includes one or more processors 247 that are configured to control operation of the modules 244, 245, 246, 248 and the data store 241. The one or more processors 247 implement and utilize the software modules, hardware components, and/or firmware elements configured to automatically configure devices at a remote site. The one or more processors 247 can include any suitable computer processors, application-specific integrated circuits (ASICs), field programmable gate array (FPGAs), or other suitable microprocessors. The one or more processors 247 can include other computing components configured to interface with the various modules and data stores of the provider system 240.

The provider system 240 includes the data store 241 configured to store configuration data, order data, device data, databases, data tables, algorithms, executable instructions (e.g., instructions for the one or more processors 247), and the like. The data store 241 can be any suitable data storage device or combination of devices that include, for example and without limitation, random access memory, read-only memory, solid-state disks, hard drives, flash drives, bubble memory, and the like. The data store 241 can be used to store a provider database similar to the provider database 142 described herein with reference to FIGS. 1A-1C, the provider database 542 described herein with reference to FIG. 2, and/or the provider database 642 described herein with reference to FIG. 6.

### Example Methods for the Automated Provisioning of a Remote Wireless Network

FIG. 3 illustrates a flow chart of an example method 300 of automatically provisioning devices of a remote network. The method 300 can be performed by any of the provider systems described herein with reference to FIGS. 1A-1C, 2, and 5. For ease of description, the method 300 will be described as being performed by a provider system. This is not to be understood to limit the scope of the disclosure. Rather, any step or portion of the method 300 can be performed by any component or combination of components of the systems described herein.

In block 350, the provider system prepares for installation of a network package on a remote network. Preparation can include preparing one or more network packages available for purchase or installation to a client. These network packages can be presented through a client portal or similar interface. Preparation can also include receiving an order for a particular network package. The order can indicate the desired network package and a remote location where the ordered network package is to be installed. Preparation can also include allocating a number of private IP addresses for the devices in the network package. Preparation can also include generating an entry or entries in a network package database indicating which devices are to be installed as part of the network package. The entry can include each device to be installed along with a status of each device.

In block 360, the provider system receives a communication from an installed controller. The provider system can use this information (e.g., a MAC address) to associate the controller to the ordered network package. The communication from the controller can be a “phoning home” process where the controller attempts to connect to the provider's network upon being installed at a remote network site. The provider system can be configured to receive this communication and to determine that a newly installed controller is ready for configuration. The provider system can then schedule the controller for configuration, as described herein.

In block 370, the provider system automatically configures the controller based on configuration settings stored at the provider system. The provider system can be configured to retrieve configuration data from a database that provides configuration settings for device types and/or for devices for use in particular network packages. The provider system is configured to automatically configure the controller based on a scheduled configuration process. The provider system generates configuration commands using one or more dedicated process daemons associated with the detected controller or its particular platform. The provider system generates configuration data and commands for the controller and an auto-configuration script on the controller can use that data and information to configure itself. As part of the configuration, the operating system and/or firmware can be upgraded or downgraded to targeted versions.

In block 380, the provider system automatically detects additional devices connected to the remote network through the controller. Once the controller is configured, the provider system can send a list of network addresses to the controller to assign to devices connected to the controller and the remote network. The provider system can use the controller to detect the presence of these devices on the network. The provider system can determine an expected number of devices based at least in part on the network package prepared in block 350.

In block 390, the provider system automatically configures the detected devices on the remote network. Similar to the configuration of the controller, the provider system can determine the platform and device type of each device, retrieve appropriate or targeted configuration data from a database, and generate configuration commands for each device. The provider system can use platform-specific daemons or processes for each device to transmit the configuration commands and accomplish the targeted configurations.

FIG. 4 illustrates a flow chart of another example method 400 of automatically provisioning devices of a remote network. The method 400 includes details and steps to expand the method 300. Similar to the method 300, the method 400 can be performed by any of the provider systems described herein with reference to FIGS. 1A-1C, 2, and 5. For ease of description, the method 400 will be described as being performed by a provider system. This is not to be understood to limit the scope of the disclosure. Rather, any step or portion of the method 400 can be performed by any component or combination of components of the systems described herein.

In block 451, the provider system receives an order for a network package. The order can be for a pre-defined network package that includes one or more network devices. The one or more network devices can include a network controller and one or more other devices such as, for example and without limitation, access points, switches, bridges, and the like. The order can be placed by a customer or client through a client portal. The network package can be configured to provide a particular network solution, such as a single hot spot, multiple hot spots, a 15-access point business deployment, etc.

In block 452, the provider system creates a network package table in a database. The network package table includes the devices in the network package and a status of each device. The network package table can include details about the devices such as device identifiers, device types, and the like. The status of each device can be initially set to pending, for example.

In block 453, the provider system allocates a number of private IP addresses for the devices in the network package. The IP addresses can be allocated as a block of addresses (e.g., sequential or otherwise related) or just a number of disparate addresses. In some embodiments, the number of addresses allocated is greater than or equal to the number of devices in the ordered network package.

In block 461, the devices are installed at a remote site. An installer can be physically at the installation site and can install the controller and other devices of the network package. As part of the installation, the installer can enter a device identifier (e.g., a MAC address) of the controller that has been installed.

In block 462, the provider system receives a device identifier for an installed controller at the remote site. This device identifier can be received from the installer through an installer portal, for example. The device identifier can be a MAC address, a device serial number, or any other suitable identifier. The controller can initiate a phone home process once installed. By way of example, the controller can first establish a VPN connection with the provider system and once the connection is established identifying information can be sent to the provider system to initiate the automated provisioning of the remote network.

In block 463, the provider system updates the status of the controller in the network package table. The status can be updated to configuring, for example. This allows other systems and personnel to monitor the status of the installation at the provider or remotely.

In block 471, the provider system sends configuration instructions and updates to the controller. A particular platform interface can be used that is associated with the platform of the controller. The platform interface sets the device's configuration system values and sends them to the provider database. A scheduling module can then schedule the controller for configuration by sending scheduling information to the provider database 410.

In some embodiments, for the controller to be configured, the platform system establishes a secure connection (e.g., using secure shell or SSH) with the controller. The provider system configures tunnels with the controller and then the controller disconnects from the provider system. The provider system then updates username, password and route information in the provider database. The controller then re-establishes a secure connection with the provider system. Through this connection, the provider system again establishes a secure connection with the controller and verifies that it can send commands to the controller. If appropriate, the provider system commands the controller to upgrade or downgrade the router operating system version and then commands the controller to reboot. After rebooting, the provider system again establishes a secure connection with the controller and commands it to upgrade or downgrade its firmware version and then commands the controller to reboot. After rebooting, the provider system again establishes a secure connection with the controller and pushes configuration information to the controller. After verifying successful configuration of the controller, the provider system sets a portal system identifier for the controller and sends that information to the provider database. In some embodiments, the provider system can be configured to use an application programming interface (API) through the platform interface to push commands to the controller to configure the controller.

In block 472, the provider system sends the allocated block of IP addresses to the controller to assign to itself and the other installed devices. The controller assigns an IP address to each device of the network package.

In block 473, the provider system receives a signal indicating that the controller has finished configuring itself. The signal can be sent from the controller through the platform interface. The signal can indicate success or failure for the configuration process. If the configuration was a failure, the provider system can re-attempt to configure the controller. In some embodiments, if the controller fails to configure one or more times, the automated provisioning process can be terminated. The installer can be notified and a new or different controller can be installed at block 461 to re-initiate the automated provisioning process.

In block 474, the provider system updates the status of the controller in the network package table. The status of the controller can be set to configured or configure failure, for example.

In block 481, the provider system discovers other devices installed on the network at the remote site. The provider system can utilize the configured controller to discover connected devices at the remote site. In some embodiments, network monitoring programs can be used to detect responses or traffic originating from one of the allocated IP addresses to detect the presence of the corresponding device.

In block 482, the provider system verifies that the discovered devices are part of the ordered network package. Once a device has been detected, information can be retrieved from the device, through the controller and a particular platform interface, that identifies the device. This information can be checked against the network package table to verify that the device is part of the network package. This information can also be used to determine the targeted or appropriate configuration for the detected device.

In block 491, the provider system sends configuration instructions and updates to the verified devices. Similar to the controller, for individual verified devices configuration commands are created using suitable or corresponding platform interfaces. The configuration commands can be sent to the individual devices through the controller.

By way of example, the provider system can use the API to push configuration commands to connected devices through the controller, thereby allowing the provider system to configure the attached devices while the controller merely provides connectivity. In this way, the controller does not configure the attached network devices but a process running on a backend system (e.g., the provider system) configures the attached network devices.

In block 492, the provider system receives signals indicating that the verified devices have finished configuring themselves. The signals can be sent from individual devices through the controller and through a suitable platform interface. The signals can indicate success or failure for the configuration process. If the configuration was a failure, the provider system can re-attempt to configure the failed device. In some embodiments, if a particular device fails to configure one or more times, the automated provisioning process can be terminated. The installer can be notified and a replacement device can be installed at block 461 to re-initiate the automated provisioning process.

In block 493, the provider system updates the status of the verified devices in the network package table. The status of individual devices can be set to configured or configure failure, for example.

### Automated Provisioning of Network Devices at a Remote Site

FIG. 5 illustrates a diagram of an example system 500 that manages user access to a provider database 542 for the automated provisioning of network devices at a remote site. The remote site is coupled to a network, such as the Internet, through a satellite network (e.g., the satellite network 110a of FIG. 1A), a terrestrial network (e.g., the terrestrial network 110b of FIG. 1B), or any other suitable communications network (e.g., the network 110 of FIG. 1C). The example system 200 provides automated provisioning through an automated provisioning system 540, similar to the provider systems 140, 240 described respectively herein with reference to FIGS. 1A-1C and 2.

The provider database 542 is similar to the provider database 142 described herein with reference to FIGS. 1A-1C. Accordingly, the provider database 542 can include an inventory table similar to the inventory table 143a, a configuration table similar to the configuration table 143b, a network package table similar to the network package table described herein, and the like. The provider database 542 can include additional databases such as a database that provides entries for available packages to be purchased or obtained from the provider. This table can include pre-defined network packages (e.g., a single hot spot, multiple hot spots, a 15-access point business deployment, etc.) that can be selected by a customer.

The system 500 allows a client 501 to access a client portal 507 to place an order for a network package. The client portal 507 can provide a list of options of pre-defined network packages for the client 501 to select. The client portal 507 can receive an order from the client 501 for a particular network package for installation at client's premises or other remote site. The client portal 507 allows a client, dealer, and/or a provider access to the provider database 542 to act in a sales capacity, e.g., by determining network packages for sale, accessing properties of devices in network packages, and/or placing orders for network packages.

The system 500 includes an IP management tool 508 that is configured to manage the allocation of private network addresses on a provider's network. The IP management tool 508 can be used to manage IP address allocation across multiple remote network sites to facilitate management of IP addresses. In some embodiments, a block of available private network addresses equal in number to at least the number of devices in a network package to be installed is set aside for a remote network that has been ordered (e.g., by the client 501 through the client portal 507). The IP management tool 508 can set aside a block of addresses at the time an order is placed for a network package. Because the IP management tool 508 allows the provider to track which IP addresses will be assigned before installation, network planning for multiple customers, in particular with respect to IP address allocation, is enhanced. In some embodiments, the IP management tool 508 can allocate extra IP addresses to anticipate expansion of a remote network site. The IP management tool 508 allows the provider to reconfigure one or more remote networks on the fly. For example, the provider can use the IP management tool 508 to pull out IP addresses, to rearrange IP address allocation, to send out new IP address blocks, and the like.

The system 500 allows an installer 502 to access an installer portal 505 to initiate the automated provisioning system when installing devices at a remote site. The installer 502 can be any person or persons that is installing network devices at a remote site. The installer 502 can use the installer portal 505 to enter a device identifier of a network controller after installation of the controller to initiate the automated configuration of the controller and connected devices. For example, the installer 502 reads the MAC address of the controller and enters it using the installer portal 505 which initiates the configuration process automatically. Once the process initiates, the automated provisioning system 540 runs without intervention from the installer 502.

The system 500 allows a provider 503 (e.g., an employee or manager that works for the provider) to import device information into the provider database 542. For example, the provider 503 can enter information about devices (e.g., in a file such as a comma separate values or CSV file) that is imported into the provider database 542. The information for individual devices can include platform, model, device type, MAC address, and the like. This information can be entered into, for example, the inventory table described herein with reference to FIG. 1A. Thus, the provider 503 can manage the inventory table, which can include a record for each piece of equipment in provider's inventory.

The automated provisioning system 540 includes a queuing scheduler 544 that is configured to schedule configuration processes for remote network devices. The queuing scheduler 544 generates configuration schedules based at least in part on detected devices at remote network sites. The queuing scheduler 544 accesses configuration data from the provider database 542 and schedules configuration jobs to be executed by the platform interfaces 546a-546c. The queuing scheduler 544 can be configured to use a network package table (e.g., the network package table described herein with respect to FIG. 1A) to search for expected devices. If the queuing scheduler 544 finds less than all of the expected devices it can schedule configuration for the found devices and keep searching for the expected devices. If one or more devices is not found, the queuing scheduler 544 can be configured to remove the device from the configuration schedule and save it for a later date. The queuing scheduler 544 schedules configuration of identified equipment based at least in part on the type of device it is and/or how that device is to be used. For example, the queuing scheduler 544 can schedule a configuration of a particular type of controller differently based on use type (e.g., single hot spot as compared to a 15-access point business deployment). Advantageously, the queuing scheduler 544 provides flexibility in the provisioning of network devices such as controllers and access points.

The automated provisioning system 540 includes platform interfaces 546a-546c that communicate with targeted devices at one or more remote network sites over a communications network (e.g., a satellite network, a terrestrial network, a hybrid network, etc.). For each type of equipment, a dedicated process or daemon can be provided by the automated provisioning system 540. This advantageously allows the automated provisioning system 540 to expand configuration capabilities to new devices and new equipment manufacturers by adding a new platform interface. In some embodiments, the platform interfaces 546a-546c are each configured for a different type of network equipment (e.g., equipment from a particular manufacturer).

By way of example, the automated provisioning system 540 includes a first platform interface 546a configured to communicate with devices belonging to a first platform (e.g., devices manufactured by the same company). The first platform can include an access point 526a and a controller 522a. The first platform interface 546a can be configured to configure the AP 526a and the controller 522a using configuration data from the provider database 542 and based on the schedule determined by the queuing scheduler 544. In some embodiments, the access point 526a and the controller 522a are a network of a first platform type being installed at the client site.

Similarly, the automated provisioning system 540 can include a second platform interface 546b that is configured to interface with a server 521 belonging to the second platform. The second platform server 521 communicates with a second platform access point 526b for configuration purposes. For example, the second platform interface 546b configures the AP 526b by sending configuration data to the server 521, the configuration data obtained from the provider database 542 and based on the schedule determined by the queuing scheduler 544. In this example, the second platform interface 546b does not communicate directly with the access point 526b, but achieves configuration of the remote AP 526b through the server 521. In some embodiments, the server 521 and the access point 526b are a network of a second platform type being installed at the client site.

Moreover, the automated provisioning system 540 can include additional platform interfaces 546c. The additional platform interfaces 546c can be used to communicate with different additional devices 525 for configuration purposes. This allows expansion of the automated provisioning system 540. In some embodiments, the additional devices 525 are a network of a third platform type being installed at the client site.

The devices 521, 522a, 525, 526a, and 526b can all be part of the same remote site or they can be different installations at different remote sites. Thus, the automated provisioning system 540 can be used to manage multiple individual installations across varied remote sites.

Furthermore, the automated provisioning system 540 allows for the addition or removal of devices after installation. A device can be added or removed by the installer 502 using the installer portal 505 which initiates configuration processes that add or remove devices from the relevant databases and configures new devices for use on the remote network.

Interaction with the provider database 542 can initiate configuration processes. For example, the queuing scheduler 544 can monitor the provider database 542 and can detect changes to relevant tables therein. If a change is detected indicating that action should be taken (e.g., a new network installation is initiating), the queuing scheduler 544 can manage the processes to be accomplished based on the detected change.

### Example Process for Automated Provisioning

FIG. 6 illustrates a diagram demonstrating the interaction of various components of an example automated provisioning system. The interactions are illustrated for the following example functions or processes generally corresponding to steps of the method 300 described herein with reference to FIG. 3: order creation 650, controller installation 660, controller configuration 670, device detection 680, and device configuration 690. Each of these processes will be described as it relates to the automated provisioning of a network package at a remote network site.

The process step 650 for creating an order can include a client 601 submitting an order to a client portal 607. The client portal 607 can then provide order information such as the client, the location, and the order number to the provider database 642. The order information can include, for example and without limitation, sales channel, license, location, order number, and the like. The creation of the order then associates the order number with an ordered network package. A network package can include the equipment to be installed at the client's requested location. Network packages for order can be pre-defined by the provider to provide a number of different remote network configurations for clients to choose from. Creation of the order can also include generating a network package table in the provider database 642 that includes the devices to be installed and the status of each device in the network package. Information about the devices can also be included in one or more tables in the provider database 642. The device information can include, for example and without limitation, platform, model, device type, MAC address, and the like. In some embodiments, creation of the order also triggers an allocation of private network addresses for each of the devices in the ordered network package.

The process step 660 for installing a controller can include an installer 602 installing a network controller 622 at the remote site. Once the controller 622 is installed, the installer 602 can provide to the provider database 642 (e.g., through an installer portal) the order number and controller identification (e.g., the controller MAC address). The process step 660 can also include physical installation of one or more additional network devices that are part of the network package such as access points, bridges, switches, routers, etc.

Installation of the controller 622 triggers the automated provisioning process 670 of the controller 622. This process can begin with the controller 622 contacting the provider system (e.g., the provider system 140 described herein with reference to FIGS. 1A-1C or the provider system 240 described herein with reference to FIG. 2). This initial contact with the provider system can be referred to as an initial phone home process. In this process, the provider database 642 can send configuration information for the newly installed controller 622 to a queuing module 644 (similar to the queuing scheduler 544 described herein with reference to FIG. 5). The queuing module 644 generates configuration scripts and sends these to the provider database 642 to schedule configuration of the controller 622. The configuration scripts are then sent to an interface module 646 (similar to the platform interfaces 546a-546c described herein with reference to FIG. 5) to generate configuration files and commands that can be understood and executed by the controller 622.

By way of example, the interface module 646 can generate commands that request the router operating system and firmware versions which are provided in reply by the controller 622. If appropriate or desirable, the interface module 646 generates scripts that may include files and/or commands requesting the controller 622 to upgrade or downgrade one or both of the router operating system or firmware. In such a scenario, the controller 622 updates the requested component and resets. Once reset, the controller 622 again sends the router operating system and firmware versions to the interface module 646. The interface module 646 then generates controller configuration scripts to configure the controller 622 for operation in the targeted remote network site. The controller 622 generates content of system-level comments and sends these to the interface module 646. Based on this content, the interface module 646 determines whether the configuration was a success or failure and reports this result to the provider database 642.

Once the controller is installed, the device detection process 680 can initiate. As part of provisioning the devices of the ordered network package, a block of private IP addresses can be set aside at the time of ordering. This block of addresses can be sent to the controller 622 from the provider database 642 through the interface module 646. The controller 622 can assign the IP addresses to itself and to the installed devices 625. The controller 622 can then detect which devices 625 have been installed and collect device identifiers from each (e.g., device name, platform, serial number, model number, manufacturer, MAC address, etc.). The controller 622 can forward device identifier information to the provider database 642. In some embodiments, this information can be used to verify that the devices 625 are part of the ordered network package by comparing the device identifier information with the information in the network package table created during the order creation process 650.

Detection of the devices 625 triggers the automated provisioning process 690 of the devices 625. The provider database 642 can send configuration information for the newly installed devices 625 to the queuing module 644. The queuing module 644 generates configuration scripts and sends these to the provider database 642 to schedule configuration of the devices 625. The configuration scripts are then sent to one or more interface modules 646 (depending on the number of different platforms of the devices 625) to generate configuration files and commands that can be understood and executed by individual devices 625. These scripts are sent through the controller 622 to the targeted devices 625.

By way of example, a particular interface module 646 can generate commands that request the operating system and firmware versions of an access point of the devices 625. These commands are sent to the controller 622 which then forwards the request to the access point. The access point provides the requested information in reply through the controller 622. If appropriate or desirable, the particular interface module 646 generates scripts that may include files and/or commands requesting the access point to upgrade or downgrade one or both of the operating system or firmware. In such a scenario, the access point updates the requested component and resets. Once reset, the access point again sends the operating system and firmware versions to the particular interface module 646 through the controller 622. The particular interface module 646 then generates device configuration scripts to configure the access point for operation in the targeted remote network site. The access point generates content of system-level comments and sends these to the interface module 646 through the controller 622. Based on this content, the particular interface module 646 determines whether the configuration was a success or failure and reports this result to the provider database 642.

### Terminology

The present disclosure describes various features, no single one of which is solely responsible for the benefits described herein. It will be understood that various features described herein may be combined, modified, or omitted, as would be apparent to one of ordinary skill. Other combinations and sub-combinations than those specifically described herein will be apparent to one of ordinary skill, and are intended to form a part of this disclosure. Various methods are described herein in connection with various flowchart steps and/or phases. It will be understood that in many cases, certain steps and/or phases may be combined together such that multiple steps and/or phases shown in the flowcharts can be performed as a single step and/or phase. Also, certain steps and/or phases can be broken into additional sub-components to be performed separately. In some instances, the order of the steps and/or phases can be rearranged and certain steps and/or phases may be omitted entirely. Also, the methods described herein are to be understood to be open-ended, such that additional steps and/or phases to those shown and described herein can also be performed.

Some aspects of the systems and methods described herein can advantageously be implemented using, for example, computer software, hardware, firmware, or any combination of computer software, hardware, and firmware. Computer software can comprise computer executable code stored in a computer readable medium (e.g., non-transitory computer readable medium) that, when executed, performs the functions described herein. In some embodiments, computer-executable code is executed by one or more general purpose computer processors. A skilled artisan will appreciate, in light of this disclosure, that any feature or function that can be implemented using software to be executed on a general purpose computer can also be implemented using a different combination of hardware, software, or firmware. For example, such a module can be implemented completely in hardware using a combination of integrated circuits. Alternatively or additionally, such a feature or function can be implemented completely or partially using specialized computers designed to perform the particular functions described herein rather than by general purpose computers.

Multiple distributed computing devices can be substituted for any one computing device described herein. In such distributed embodiments, the functions of the one computing device are distributed (e.g., over a network) such that some functions are performed on each of the distributed computing devices.

Some embodiments may be described with reference to equations, algorithms, and/or flowchart illustrations. These methods may be implemented using computer program instructions executable on one or more computers. These methods may also be implemented as computer program products either separately, or as a component of an apparatus or system. In this regard, each equation, algorithm, block, or step of a flowchart, and combinations thereof, may be implemented by hardware, firmware, and/or software including one or more computer program instructions embodied in computer-readable program code logic. As will be appreciated, any such computer program instructions may be loaded onto one or more computers, including without limitation a general purpose computer or special purpose computer, or other programmable processing apparatus to produce a machine, such that the computer program instructions which execute on the computer(s) or other programmable processing device(s) implement the functions specified in the equations, algorithms, and/or flowcharts. It will also be understood that each equation, algorithm, and/or block in flowchart illustrations, and combinations thereof, may be implemented by special purpose hardware-based computer systems which perform the specified functions or steps, or combinations of special purpose hardware and computer-readable program code logic means.

Furthermore, computer program instructions, such as embodied in computer-readable program code logic, may also be stored in a computer readable memory (e.g., a non-transitory computer readable medium) that can direct one or more computers or other programmable processing devices to function in a particular manner, such that the instructions stored in the computer-readable memory implement the function(s) specified in the block(s) of the flowchart(s). The computer program instructions may also be loaded onto one or more computers or other programmable computing devices to cause a series of operational steps to be performed on the one or more computers or other programmable computing devices to produce a computer-implemented process such that the instructions which execute on the computer or other programmable processing apparatus provide steps for implementing the functions specified in the equation(s), algorithm(s), and/or block(s) of the flowchart(s).

Some or all of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid state memory chips and/or magnetic disks, into a different state.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list. The word “exemplary” is used exclusively herein to mean “serving as an example, instance, or illustration.” Any implementation described herein as “exemplary” is not necessarily to be construed as preferred or advantageous over other implementations.

The disclosure is not intended to be limited to the implementations shown herein. Various modifications to the implementations described in this disclosure may be readily apparent to those skilled in the art, and the generic principles defined herein may be applied to other implementations without departing from the spirit or scope of this disclosure. The teachings of the invention provided herein can be applied to other methods and systems, and are not limited to the methods and systems described above, and elements and acts of the various embodiments described above can be combined to provide further embodiments. Accordingly, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A provider system configured for automated configuration of devices installed at a remote site, the system comprising:
a communications bus configured to receive network communication from a remote network site over a communications network;
a storage device comprising a provider database that stores configuration information for a plurality of network devices including a network controller and a network access point;
one or more processors configured to execute computer executable instructions stored on the storage device;
a device monitoring module that utilizes the one or more processors to receive a unique identifier of a controller installed at a remote network site over the communications network;
a network package module that utilizes the one or more processors to associate the received unique identifier with an ordered network package;
a scheduling module that utilizes the one or more processors to automatically generate a configuration script for the controller based on configuration information extracted from the provider database; and
a plurality of platform interface modules that utilize the one or more processors to receive the configuration script for the controller, to select an appropriate platform interface module that is configured to interface with a platform of the controller, and to transmit configuration commands that automatically configure the controller based on the ordered network package.

2. The system of claim 1 wherein the provider database includes an inventory table that includes individual records for network equipment in an inventory of the provider.

3. The system of claim 2 wherein individual records of the inventory table includes a unique device identifier and a device type identifier indicating the type of equipment.

4. The system of claim 3 wherein the provider database includes a configuration table that includes individual records for unique device type identifiers included in the inventory table.

5. The system of claim 4 wherein individual records of the configuration table includes the unique device type identifier and configuration data for configuring a device associated with the unique device type identifier.

6. The system of claim 5 wherein the scheduling module is configured to generate the configuration script for the controller based at least in part on records of the configuration table associated with the unique device type identifier of the controller.

7. The system of claim 1 wherein the device monitoring module further utilizes the one or more processors to detect one or more network access points connected to the controller.

8. The system of claim 7 wherein the scheduling module further utilizes the one or more processors to schedule access point configuration scripts for the one or more detected network access points.

9. The system of claim 8 wherein the plurality of platform interface modules further utilizes the one or more processors to receive the access point configuration scripts, to select an appropriate platform interface module that is configured to interface with a platform of a detected access point, and to transmit configuration commands that automatically configure the detected access point based on the ordered network package.

10. The system of claim 9 wherein the appropriate platform interface module for the detected access point is different from the appropriate platform interface module for the controller.

11. The system of claim 7 wherein the device monitoring module further utilizes the one or more processors to change a status of the controller and the one or more detected access points in the provider database based on results of the transmitted configuration commands.

12. The system of claim 1 wherein the communications network comprises a satellite communications system.

13. A method for automatically provisioning devices installed at a remote site to provide a wireless network, the method comprising:
receiving, over a communications network, a communication from an installed controller at a remote network site, the communication including a unique device identifier of the installed controller;
automatically generating configuration commands using a provider database based at least in part on the unique device identifier of the installed controller, the configuration commands generated using a platform-specific module associated with the installed controller;
detecting, over the communications network, a network access point connected to the installed controller; and
automatically generating configuration commands using a provider database based at least in part on a unique device identifier of the network access point, the configuration commands generated using a platform-specific module associated with the network access point.

14. The method of claim 13 wherein the platform-specific module associated with the installed controller is different from the platform-specific module associated with the network access point.

15. The method of claim 13 further comprising identifying an associated network package order based at least in part on the unique device identifier of the installed controller.

16. The method of claim 13 wherein the unique device identifier of the installed controller is a media access control address.

17. The method of claim 13 further comprising transmitting a block of network addresses to the installed controller.

18. The method of claim 17 wherein the installed controller is configured to assign a network address to the network access point from the transmitted block of network addresses.

19. The method of claim 13 further comprising detecting, over the communications network, a second network access point connected to the installed controller.

20. The method of claim 19 further comprising automatically generating second network access point configuration commands using a provider database based at least in part on a unique device identifier of the second network access point, the second network access point configuration commands generated using a platform-specific module associated with the second network access point that is different from the platform-specific module associated with the first network access point.
